(19) United States
(12) Patent Application Publication
(10) Pub. No.: US 2006/0074753 A1
(43) Pub. Date: Apr. 6, 2006

(54) Advertising during printing of secure customized coupons

(75) Inventors: James M. Schuh, Appleton, WI (US); James T. Tanner, Winneconne, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/959,842

(22) Filed: Oct. 6, 2004

(51) Int. Cl. G06Q 30/00

(52) U.S. Cl. 705/14

(57) ABSTRACT

A method for providing interstitial advertising during computer-enabled print time for a network-based coupon provider includes a first step of providing a coupon provision application via a network-accessible website interface, wherein the coupon provision application provides features by which a user can select various coupons for printing. Input from a user then generates a trigger signal representative of the desired coupons for printing (e.g., a selection of total coupons or a command to print the selected coupons). Upon receipt of this trigger signal, the desired coupons are printed while an interstitial advertisement or interactive display is also implemented in a substantially simultaneous fashion. Such advertisement or interactive communication may correspond to an interface for newsletter signup, an interactive survey or opinion poll, an interactive game with incentive prizes, a local information display, a static or rich media brand message or initiated web page, a music download offer with audio excerpt, and/or a screen saver with integrated sales or brand message.

### BACKGROUND OF THE INVENTION

Conventional advertising has long targeted consumers via such media as radio, television, print media, billboards, home mailings, etc. With the advent of an increasingly digital era, a greater focus on consumer advertising via computer-accessible media has emerged. Targeted advertising to consumers who access various web-based sites via a home computer or other access station has developed into a viable and important form of promoting an advertiser's product(s) and/or service(s).

One example of known technology that relates to the advancing utilization of network-distributed advertising corresponds to “Superstitials” offered by Unicast Communications Corporation, which play ads over web pages within windows in a manner transparent to a user situated at a given browser. This is one of several forms of “interstitial” advertising, in which dead time on a modem is used to download advertisements that can be displayed during use of a browser. Additional exemplary details of such technology are disclosed in U.S. Patent Application Publication U.S. 2003/0028565 (Landsman et al.).

Yet another notable feature employed by product/service providers to target consumers in a computer-networked environment concerns providing coupons to consumers for use in various retail environments. Several avenues currently exist by which a consumer can access and print secure, customized coupons from a networked database environment (e.g., via the Internet). Known exemplary online coupon providers include those developed by such entities as Coolsavings, Coupons Inc., and E-Centives.

When consumers print customized coupons in an online environment, they typically have to wait for the coupon to print before the printing process is completed (at which point they are often presented with a “thank you” message or screenshot informing the consumer that their coupons have printed.) During the coupon print time, known online coupon providers sometimes show the consumer standard displays such as a text-based image instructing the consumer to “Please Wait” or a graphical image of a computer and printer communicating.

Various features associated with some known coupon printing technologies can be found in U.S. Pat. No. 6,321,208 (Barnett et al.), which discloses a system for electronic distribution of product redemption coupons to remote personal computers in users' homes. A centrally located repository, such as an online service provider or Web site on the Internet, stores packages of coupon data for downloading on demand to the user's computer. The user may view, select, sort and print desired coupons from the downloaded package. The user's demographic as well as coupon selection data are provided back to the online service and coupon distributor and issuers for subsequent marketing analysis. The online service can perform subsequent coupon processing on previously downloaded coupon packages such as variation of discount amounts. The online service provider can also determine how many times a particular coupon was viewed. When the printed coupons are presented at a retail store, the discount is provided to the user. Barnett et al. also generally refers to advertisements that are associated with coupon information.

In an alternative coupon printing application such as disclosed in U.S. Pat. No. 4,674,041 (Lemon et al.), a system with remotely located coupon printing stations is capable of limiting the number of coupons printed in a given time period. Each coupon station has a display for indicating the number of coupons printed in a given time period. Each coupon station has a display for indicating the available coupons, selections means to allow the consumer to choose the desired coupon, and a coupon printer. The system disables display of a particular coupon when a preselected coupon limit has been reached.

Yet another system disclosed in U.S. Pat. No. 5,176,224 concerns a closed-loop system which consists of a kiosk-type printer station located at a retail store. The kiosk is linked to manufacturer(s) in order to obtain specific coupon information. The consumer selects the desired coupon at the kiosk, and the coupon is printed and dispensed. The consumer presents the coupon at the register, where the discount is applied and the discount transaction data is transmitted back to the manufacturer.

Additional methods of providing customized coupons to customers are disclosed in U.S. Patent Application Publication Nos. U.S. 2002/0087405 (Barnett et al.) and U.S. 2002/0198957 (Amjadi). PCT International Application Publication WO 99/35551 (Lyons et al.) discusses an incentive network equipped with methods for distributing incentives on a network-wide basis and for permitting user access to individual incentives from any network server.

All of the aforementioned patents and published patent application publications are hereby incorporated into this application for all purposes.

The aforementioned coupon and incentive provision technologies do not currently take advantage of the down time during which customized coupons are printed. More particularly, none of the aforementioned coupon providers apparently provide features for implementing interactive advertisement with the consumer during such time. As such, a need currently exists for a web-based system and method for providing and printing of secure customized coupons for a consumer while taking advantage of coupon print time to provide static or interactive advertisement options for the consumer.

### SUMMARY OF THE INVENTION

Objects and advantages of the invention will be set forth in part in the following description, or may be obvious from the description, or may be learned through practice of the invention.

In general, aspects of the present invention are directed to a system and method for coupon provision that incorporates interstitial advertising specifically occurring during at least a portion of the coupon printing process. It is desired to take advantage of the coupon printing period of a coupon provision system and method when a consumer would otherwise be waiting to present them with advertisements that might provide additional benefits for both the consumer and advertiser.

It is a particular advantage in accordance with some embodiments of the present invention to present interstitial advertisements in the down time associated with a coupon printing process because of the potential for positive consumer reaction. Many consumers access coupon provision technologies looking for information or incentives for a particular product type or brand name. In such instances, interstitial advertisements offering additional information, rebates or incentives for the particular product or brand may be highly desired by the user. In some cases, a user would be much less prone to ignore such an advertisement in this type of environment than in other online or computer-based environments. This reaction is due to the fact that the consumers will have to wait anyways for their coupons to print, and they know that the advertisers they will see in such an interstitial advertisement are likely paying for the coupon provision service they are using.

Another advantage in accordance with certain embodiments of the invention is that a relatively large amount of versatility is afforded to the type of interstitial advertisements that may be implemented during coupon print time. Further, many of the advertising options are interactive displays or communications that require input from the user. This type of advertisement may offer the benefit of achieving increased user interest levels since it gets them involved on more than just a viewing level.

One embodiment of the present invention corresponds to a method for providing interstitial advertising during computer-enabled print time for a network-based coupon provider. A first exemplary step in such a method is to provide a coupon provision application via a network-accessible website interface. The coupon provision application provides features whereby a user can select various coupons for viewing, sorting, and ultimate printing. Input from a user then generates a trigger signal representative of the desired coupons for printing (e.g., a selection of total coupons or a command to print the selected coupons). Upon receipt of this trigger signal, the desired coupons are printed while an interstitial advertisement or interactive display is also implemented in a substantially simultaneous fashion. The interstitial advertisement may be terminated either automatically upon completion of the advertisement or upon user selection of a termination feature, at which point the printed coupons can be retrieved.

Yet another exemplary embodiment of the present invention concerns a computer-based application for providing customized coupons selectable via a secure network interface and for displaying interstitial advertisements during coupon print time. The computer-based application includes a web-based interface, a signal generator and an application program. The web-based interface is accessible by a user via a secure network environment (e.g., the Internet) and provides a plurality of coupons from which the user selects a customized group for printing. The group can comprise one or more coupons. The signal generator then sends a trigger signal to an application program upon user instruction to print the selected group of coupons upon which the application program provides an interactive display to the user via the web-based interface. Implementation of the trigger signal by the signal generator may occur upon user actuation of a predetermined input sequence at a peripheral device coupled to the user's computer.

A still further exemplary embodiment of the present invention concerns an article of manufacture including a program storage medium (e.g., some combination of distributed or non-distributed volatile and/or non-volatile memory elements) readable by a computer having a memory. The program storage medium tangibly embodies one or more programs of instruction executable by the computer to perform method steps for providing interstitial advertising during printing of selected consumer coupons. The program implementation steps more particularly correspond to providing a coupon provision application via a network-accessible website interface, receiving input from a user representative of desired coupons for printing, and printing the desired coupons while in a substantially simultaneous time frame generating an interactive display for the user.

The interstitial advertisement or interactive communication displayed in the above exemplary embodiments may correspond to a variety of particular features, including but not limited to an interface for newsletter signup, an interactive survey or opinion poll, an interactive game with incentive prizes, a local information display, a static or rich media brand message or initiated web page, a music download offer with audio excerpt, and/or a screen saver with integrated sales or brand message.

Other features and aspects of the present invention are discussed in greater detail below.

### BRIEF DESCRIPTION OF THE DRAWING

FIG. 1 provides a block diagram illustration of exemplary steps in one embodiment of a method for providing interstitial advertising during printing of customized consumer coupons in accordance with the present invention; and

FIG. 2 provides a schematic representation of the interaction among exemplary hardware components of a coupon provision application with interstitial advertising as networked from an advertiser server to a consumer computer in accordance with the present invention;

FIGS. 3A and 3B provide exemplary screen shot displays employed during coupon printing for known online coupon providers; and

FIG. 4 provides an exemplary screen shot with various options for the interstitial advertising employed during coupon printing in accordance with the coupon provision application and associated features in accordance with embodiments of the present invention.

### DETAILED DESCRIPTION OF THE INVENTION

The invention will now be described in detail with reference to particular embodiments thereof. The embodiments are provided by way of explanation of the invention, and are not meant as a limitation of the invention. It will be apparent to those skilled in the art that various modifications and variations can be made in the present invention without departing from the scope and spirit of the invention. For example, features described or illustrated as part of one embodiment may be used with another embodiment to yield a still further embodiment. Thus, it is intended that the present invention include these and other modifications and variations as come within the scope and spirit of the invention, including the appended claims and their equivalents.

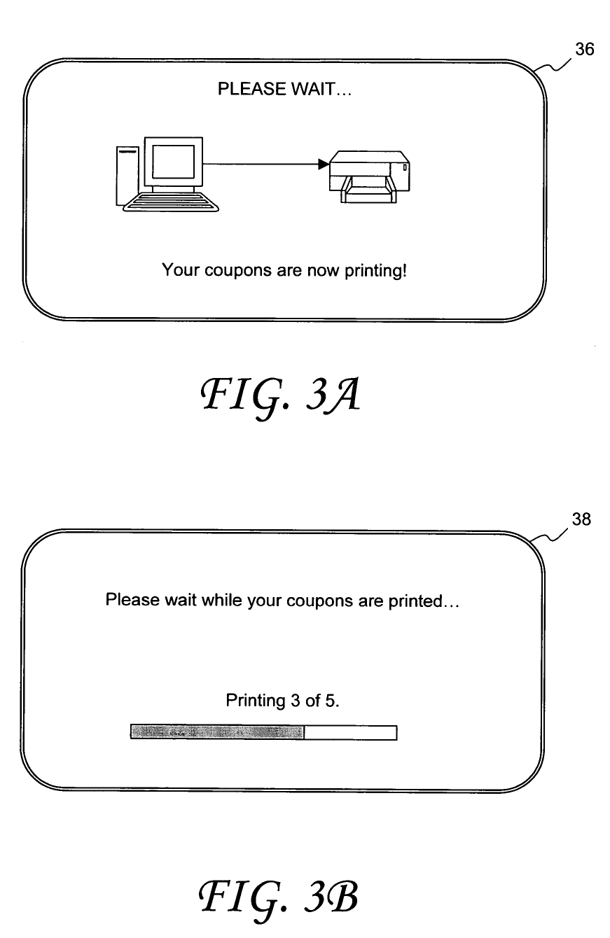

As mentioned in the Background of the Invention section above, many known systems exist for providing coupons or incentives to a consumer either through the consumer's home computer or through designated kiosk or similar machines. Via these conventional coupon technologies, users are able to selectively choose desired coupons for viewing, sorting and ultimate printing for later discount use in a retail environment. After coupon selection by a user, some period of time often passes during which the selected coupons are being printed. During this coupon printing period, the system providing the coupons often shows a simple text or graphic to a user via a system display, examples of which are illustrated in FIGS. 3A and 3B. The display (i.e., screen shot) 36 of FIG. 3A shows respective graphic representations of a computer and a printer in communication with one another while also showing a message to the user to wait while his/her selected coupons are printed. The display 38 of FIG. 3B displays a similar text message and a graphical representation of the elapsed and pending print status for the total group of selected coupons.

In accordance with embodiments of the present invention, it is desired to take advantage of the coupon printing period of a coupon provision system and method when a consumer would otherwise be waiting to present them with some sort of interstitial advertisement. An interstitial advertisement generally refers to an advertisement, often implemented in a computer-based environment, that is presented “in between” start and destination actions or viewing locations. It is a particular advantage to present such interstitial advertisements in the down time associated with a coupon printing process because of the potential for positive consumer reaction. Many consumers access coupon provision technologies looking for information or incentives for a particular product type or brand name. In such instances, interstitial advertisements offering additional information, rebates or incentives for the particular product or brand may be highly desired by the user. In some cases, a user would be much less prone to ignoring such an advertisement in this type of environment than in other online or computer-based environments. This reaction is due to the fact that the consumers will have to wait anyway for their coupons to print, and they know that the advertisers they will see in such an interstitial advertisement are likely paying for the coupon provision service they are using.

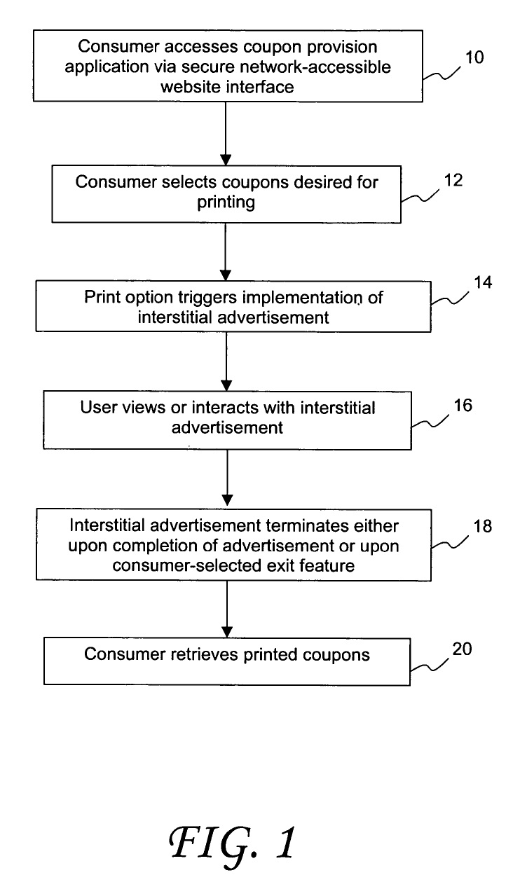

As such, aspects of the present invention are directed to a system and method for coupon provision that incorporates interstitial advertising specifically occurring during at least a portion of the coupon printing process. Referring now to FIG. 1, exemplary steps associated with one embodiment of a method in accordance with the present invention is illustrated in a block diagram form. A first step 10 in this exemplary method regards offer of a coupon provision application which is accessible by a consumer via a secure network-accessible website interface. The consumer accesses the coupon provision application and then selects in step 12 the desired coupons for printing. Once the consumer finishes coupon selection, a print option is triggered either automatically or by user selection. The triggered print option is monitored by the subject coupon provision application, and upon printing an interstitial advertisement is implemented on a user display in step 14. In one embodiment, the triggered print option sends a substantially simultaneous trigger signal to the coupon provision application or to the system implementing such application such that the interstitial advertisement occurs at least partially during the coupon printing time frame. In step 16, the user then views or interacts as required with the interstitial advertisement. The interstitial advertisement terminates in step 18 either automatically upon completion of the advertisement or upon an optional user-selected exit feature. For example, the advertisement may be provided with a “close” tab that may be selected by the user at any time during the advertisement. Alternatively, the user may be prompted with a display at the beginning of the interstitial advertisement asking for their decision “yes” or “no” to view such an ad. If the user selects “no”, the advertisement may be terminated. The consumer then retrieves the printed coupons in step 20. It may or may not be necessary for step 18 to be completely finished before the consumer is actually able to retrieve the printed coupons.

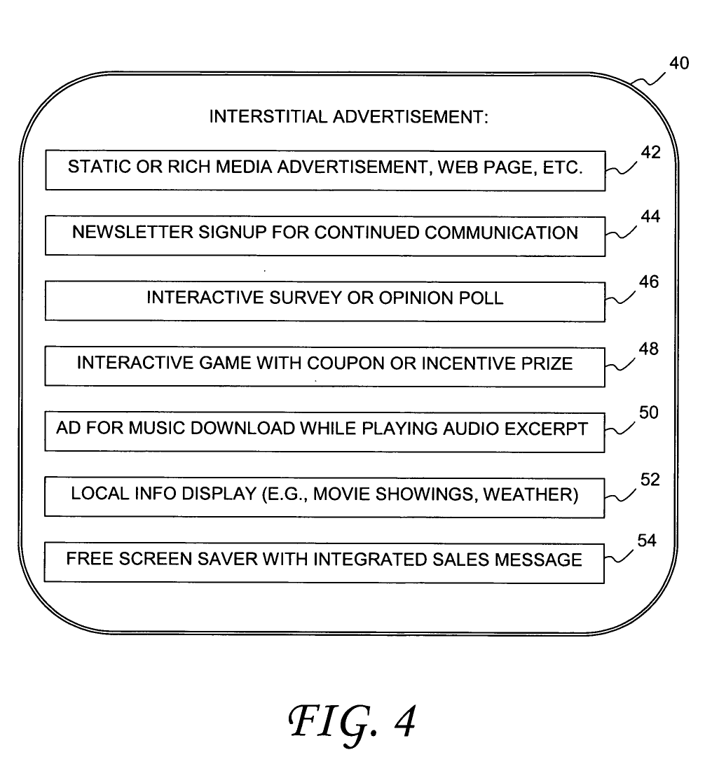

The coupon printing process can trigger substantially simultaneous implementation of many different types of interstitial advertisements. Exemplary types of advertisements are represented in the screen shot 40 of FIG. 4, and are presented in no particular order of significance. A first interstitial advertisement option 42 corresponds to providing a static or rich media advertisement, such as a pre-formatted brand message or graphic banner, or an initiated link to one or more given web pages. Second option 44 provides an interface by which a user can sign up for a newsletter. An example of a potential newsletter corresponds to a newsletter that would provide continued communication with parents (who might be selecting such coupons as diaper coupons, etc.). Newsletters provide more than a one-time advertisement, offer much more interaction to a consumer than some advertisement displays, and yield an increased potential for subsequent business. A third option 46 corresponds to providing an interactive survey or opinion poll for a user to complete, upon which point the user may be offered additional coupons, sometimes more valuable, or other incentives. A similar reward may be provided to a consumer in option 48 after the consumer completes an interactive game provided to them (e.g., puzzle, trivia question(s), maze, etc.). A still further option 50 for an interstitial advertisement in accordance with the present invention corresponds to an ad for a music download of a song, album or other selection. During a visually enticing display for the music, an audio excerpt of the music could also be playing. Another option 52 corresponds to providing an information display for the predetermined local area of the consumer. Local information could correspond without limitation to such information as local weather reports, current news, sports or stock headlines, or current local movie listings. Option 54 corresponds to the provision of a free screen saver that communicates some sort of integrated sales message to the user while also providing clever or stimulating visual appeal. Ideally, the appeal of the screensaver dynamics and graphics would overcome a consumer's potential resistance to having a brand or logo showing on one's computer. It should be appreciated that many different types of particular interstitial advertising and corresponding interactive communications may be implemented during a coupon printing process in accordance with the present invention. As such, embodiments of the present invention should not be unnecessarily limited to the specific examples disclosed above.

Many of the above options are interactive displays or communications that require input from the user. This type of advertisement may offer the benefit of achieving increased user interest since it gets them involved on more than just a viewing level. It should be appreciated that in embodiments of the present invention where many options exist for the type of interstitial advertisement implemented during the coupon printing process, a user may select which type of communication they prefer so that subsequent visits to the given coupon provision application provide not only customized coupons but customized advertisements during printing of the selected coupons. For example, based on user selection, the user will always be offered an interactive game to play or local weather information during coupon print time.

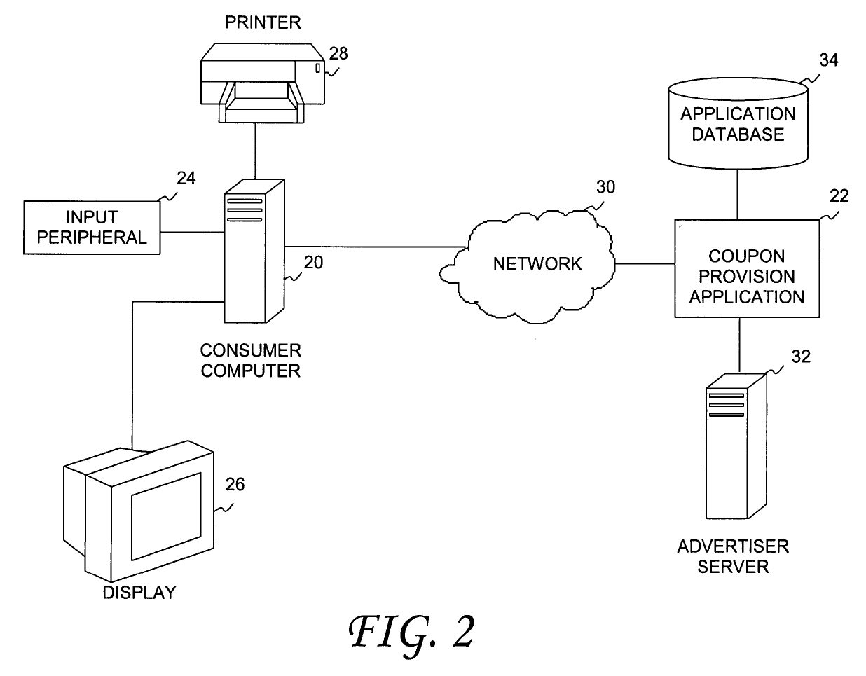

Referring now to other aspects of the present invention, FIG. 2 illustrates an exemplary relationship among several hardware components used in one embodiment of a coupon provision application in accordance with the present invention. In the exemplary embodiment of FIG. 2, multiple consumers 20 (only one of which is illustrated in FIG. 2) can access the coupon provision application or program 22. Each consumer has access to coupon provision application 22 via a computer that is interfaced to one or more input peripheral devices 24 (e.g., a keyboard, touch-screen monitor, mouse, scanner, etc.). Input peripheral devices may be employed by a consumer to select coupons via coupon provision application 22, signal when to print selected coupons (thus generating a trigger signal informing the application 22 when to display interstitial advertisements), as well as provide interactive input during the advertisement or user communication. Consumer computers 20 may also be coupled to such devices as a display 26 (e.g., monitor, television, etc.) for viewing the information obtained from coupon provision application 22. A printer 28 may also be provided for printing the coupons selected in the coupon provision application.

Consumers 20 are in communication with a network 30, which may correspond to a dial-in network, local area network (LAN), wide area network (WAN), public switched telephone network (PSTN), Internet, Intranet, Ethernet type networks and others. An interface to the coupon provision application 22 may be provided to consumers as a secure web page, other browser interface or visual display. Input peripheral devices 24 provided in association with consumer computers 20 linked to network 30 can be employed to enter a URL to access a secure web site. The URL request goes through the network to a router (not shown) where an advertiser server 32 determines the IP address to be used for the requested URL. A signal for creating a web page display is then routed back to the requester's computer. In some exemplary embodiments, advertiser server 32 and other hardware or software components coupled directly thereto may be associated with equipment operated by or per the instruction of product manufacturers seeking to provide advertising for their products and/or services. In other exemplary embodiments, such physical components may be utilized by third-party advertisers. In still further embodiments, components of a product manufacturer may be linked to those of a third-party advertiser to jointly implement desired advertising arrangements in accordance with the presently disclosed technology.

Advertiser server 32 is further configured to execute specific code or software included in coupon provision application 22. In one example, the code or software included as an integral part of coupon provision application 22 can be viewed as information stored in a program storage medium, such as but not limited to any combination of volatile memory (e.g., random access memory (RAM, such as DRAM, SRAM, etc.) and nonvolatile memory (e.g., ROM, flash, hard drives, magnetic tapes, CDROM, DVDROM, etc.). The program storage medium is configured for reading and execution by a computer (e.g, advertiser server 32). The program storage medium embodying one or more programs of instruction executable by such computer may be located on an application database 34. Application database 34 may be provided on advertiser server 32 or on a separate dedicated server, and in addition to storing programs of instruction can store data associated with the demographics or user preferences of consumers accessing the subject coupon provision application. This type of information can be used to choose what type of interstitial advertisements to display to the user or to assist with subsequent analysis of user-provided input and information gathered during the coupon printing and simultaneous advertising process.

It should be appreciated that although exemplary features are described above with respect to FIG. 2 for implementing exemplary steps and features of the present invention, such steps and features can alternatively be implemented in conjunction with other known or newly developed coupon or incentive provision systems and technologies, such as those described in the Background of the Invention section.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention.

What is claimed is:

1. A method for providing interstitial advertising during computer-enabled print time for a network-based coupon provider, said method comprising the steps of:
providing a coupon provision application via a network-accessible website interface, wherein said coupon provision application provides features by which a user can select various coupons for printing;
receiving a trigger signal representative of user-generated input to print the coupons selected via the coupon provision application;
upon receipt of the trigger signal, providing an interstitial advertisement to the user via the coupon provision application for viewing on a user display; and
terminating the interstitial advertisement.

2. The method of claim 1, whereby the display of the interstitial advertisement occurs at least partially during the time it takes to print the selected coupons.

3. The method of claim 1, wherein the user can retrieve the selected printed coupons after said terminating step.

4. The method of claim 1, wherein the step of terminating the interstitial advertisement occurs automatically upon completion of the provided interstitial advertisement.

5. The method of claim 1, wherein the step of terminating the interstitial advertisement occurs upon user selection of a provided exit feature.

6. The method of claim 1, wherein said step of providing an interstitial advertisement further comprises providing a static or rich media visual display via a pre-formatted graphic banner or an initiated link to a given web page.

7. The method of claim 1, wherein said step of providing an interstitial advertisement further comprises providing an interface by which the user can sign up for a newsletter.

8. The method of claim 1, wherein said step of providing an interstitial advertisement further comprises providing an interactive survey or opinion poll for the user to complete.

9. The method of claim 8, further comprising a step of offering the user additional coupons or incentives upon completion of the interactive survey or opinion poll provided in said step of providing an interstitial advertisement.

10. The method of claim 1, wherein said step of providing an interstitial advertisement further comprises providing an interactive game for the user to participate in.

11. The method of claim 10, further comprising a step of offering the user additional coupons or incentives upon completion of the interactive game provided in said step of providing an interstitial advertisement.

12. The method of claim 1, wherein said step of providing an interstitial advertisement further comprises displaying user-selected local information corresponding to one or more of current news, sports or stock headlines, current weather report and current movie listings.

13. The method of claim 1, wherein said step of providing an interstitial advertisement further comprises showing an advertisement for a music download.

14. The method of claim 13, further comprising a step of providing an audio excerpt of the music advertised in said step of providing an interstitial advertisement.

15. The method of claim 1, wherein said step of providing interstitial advertising further comprises offering a free screen saver to the user.

16. The method of claim 15, wherein the screen saver offered in said step of providing an interstitial advertisement incorporates a sales or brand message therein.

17. A computer-based application for providing coupons selectable via a secure network interface and for displaying interstitial advertisements during coupon print time, said system comprising:
a web-based interface accessible by a user via a secure network environment, the web-based interface displaying a plurality of coupons from which the user selects a group for printing;
a signal generator configured to send a trigger signal to an application program via the secure network environment upon user instruction to print the selected group of coupons; and
an application program adapted to receive the trigger signal generated by said signal generator and to provide an interactive visual display to the user via the web-based interface.

18. The computer-based application of claim 17, wherein said web-based interface is accessible via the Internet.

19. The computer-based application of claim 17, wherein the trigger signal implemented by said signal generator occurs upon user actuation of a predetermined input sequence by the user at a peripheral device coupled to a user's computer.

20. The computer-based application of claim 17, wherein the application program is configured to provide a static or rich media visual display via a pre-formatted graphic banner or an initiated link to a given web page.

21. The computer-based application of claim 17, wherein the application program is configured to provide an interface by which the user can sign up for a newsletter.

22. The computer-based application of claim 17, wherein the application program is configured to provide an interactive survey or opinion poll for the user to complete.

23. The computer-based application of claim 22, wherein the application program is further configured to offer the user additional coupons or incentives upon completion of the interactive survey or opinion poll provided to the user.

24. The computer-based application of claim 17, wherein the application program is configured to provide an interactive game for the user to participate in.

25. The computer-based application of claim 24, wherein the application program is further configured to offer the user additional coupons or incentives upon completion of the interactive game provided to the user.

26. The computer-based application of claim 17, wherein the application program is configured to display user-selected local information corresponding to one or more of current news, sports or stock headlines, current weather report and current movie listings.

27. The computer-based application of claim 17, wherein the application program is configured to display an advertisement for a music download.

28. The computer-based application of claim 27, wherein the application program is further configured to provide an audio excerpt of the advertised music for the user to listen to.

29. The computer-based application of claim 17, wherein the application program is configured to offer a free screen saver to the user.

30. The computer-based application of claim 29, wherein the screen saver offered to the user incorporates a sales or brand message therein.

31. An article of manufacture comprising a program storage medium readable by a computer having a memory, the medium tangibly embodying one or more programs of instructions executable by the computer to perform method steps for providing interstitial advertising during the printing of selected consumer coupons, said method comprising the following steps:
providing a coupon provision application via a network-accessible website interface, wherein said coupon provision application provides features by which a user can select various coupons for printing;
receiving input from a user representative of the desired coupons for printing; and
printing the desired coupons selected by the user and in a substantially simultaneous time frame generating an interactive display for access by the user.

32. The article of manufacture of claim 31, wherein said step of generating an interactive display further comprises providing an interface by which the user can sign up for a newsletter.

33. The article of manufacture of claim 31, wherein said step of generating an interactive display further comprises providing an interactive survey or opinion poll for the user to complete.

34. The article of manufacture of claim 33, further comprising a step of offering the user additional coupons or incentives upon completion of the interactive survey or opinion poll provided in said step of generating an interactive display.

35. The article of manufacture of claim 31, wherein said step of generating an interactive display further comprises providing an interactive game for the user to participate in.

36. The article of manufacture of claim 35, further comprising a step of offering the user additional coupons or incentives upon completion of the interactive game provided in said step of generating an interactive display.

37. The article of manufacture of claim 31, wherein said step of generating an interactive display further comprises displaying user-selected local information corresponding to one or more of current news, sports or stock headlines, current weather report and current movie listings.

38. The article of manufacture of claim 31, wherein said step of generating an interactive display further comprises showing an advertisement for a music download.

39. The article of manufacture of claim 38, further comprising a step of providing an audio excerpt of the music advertised in said step of generating an interactive display.

40. The article of manufacture of claim 31, wherein said step of generating an interactive display further comprises offering a free screen saver to the user.

41. The article of manufacture of claim 40, wherein the screen saver offered to the user in said step of generating an interactive display incorporates a sales or brand message therein.
